(19) United States
(12) Patent Application Publication
(10) Pub. No.: US 2025/0219234 A1
(43) Pub. Date: Jul. 3, 2025

(54) BATTERY PACK

(71) Applicant: BLACK & DECKER INC., New Britain, CT (US)

(72) Inventor: DANIEL CHIZHIK, Towson, MD (US)

(21) Appl. No.: 18/989,881

(22) Filed: Dec. 20, 2024

Related U.S. Application Data
(60) Provisional application No. 63/615,018, filed on Dec. 27, 2023.

(51) Int. Cl. H01M 50/291; H01M 50/211; H01M 50/258

(52) U.S. Cl. CPC H01M 50/291; H01M 50/258; H01M 50/211

(57) ABSTRACT

The present disclosure is directed to a battery pack including a battery pack housing and a core pack within the battery pack housing. The core pack may include a cell holder and a plurality of battery cells held in place by the cell holder. The battery pack also includes a gap pad. The gap pad is affixed to the core pack. The gap pad may be positioned between the core pack and the battery pack housing. The gap pad may include a plurality of predefined bend lines to enable the gap pad to be bent or partially folded about the core pack.

### RELATED APPLICATIONS

This application claims the benefit of priority under 35 U.S.C. § 119(e) to U.S. Provisional Patent Application Ser. No. 63/615,018, filed Dec. 27, 2023, titled “Battery Pack.”

### TECHNICAL FIELD

This application relates to a battery pack and a method for manufacturing and assembling a battery pack. In one implementation, the battery pack includes a plurality of pouch type battery cells and a gap pad assembly about the plurality of pouch type battery cells.

### BACKGROUND

The instant application describes an example embodiment gap pad assembly for a battery pack.

### SUMMARY

An aspect of the present disclosure includes a gap pad between a plurality of battery cells and a battery pack housing.

Another aspect of the present disclosure includes a gap pad having a plurality of predefined bend lines to enable improved assembly of the battery pack.

Another aspect of the present disclosure includes a battery pack including a gap pad between a plurality of battery cells and a battery pack housing.

Another aspect of the present disclosure includes a battery pack including a gap pad having a plurality of predefined bend lines to enable improved assembly of the battery pack.

An example embodiment of the aforementioned battery pack may include a core pack including a battery cell holder and a plurality of battery cells, the core pack having a first side, a second side generally perpendicular to the first side and a third side generally perpendicular to the second side and generally opposed and parallel to the first side; and a gap pad, the gap pad including (a) a first section, (b) a second section, and (c) a third section, the first section of the gap pad coupled to the first side of the core pack, the second section of the gap pad coupled to the second side of the core pack, and the third section of the gap pad coupled to the third side of the core pack.

The aforementioned example embodiment may include a battery pack in which the plurality of battery cells has a first exposed area on the first side of the core pack, a second exposed area on the second side of the core pack, and a third exposed area on the third side of the core pack and the first section of the gap pad is coupled to the first exposed area of the battery cells on the first side of the core pack, the second section of the gap pad is coupled to the second exposed area of the battery cells on the second side of the core pack, and the third section of the gap pad is coupled to the third exposed area of the battery cells on the third side of the core pack.

The aforementioned example embodiment may include a battery pack in which an area of the first section of the gap pad is approximately equal to the first exposed area of the battery cells on the first side of the core pack and an area of the second section of the gap pad is approximately equal to the second exposed area of the battery cells on the second side of the core pack and an area of the third section of the gap pad is approximately equal to the third exposed area of the battery cells.

The aforementioned example embodiment may include a battery pack in which an area of the first section of the gap pad is defined by a first dimension and a second dimension and the first exposed area of the battery cells on the first side of the core pack is defined by a first dimension and a second dimension and wherein the first dimension and the second dimension of the area of the first section of the gap pad are approximately equal to the first dimension and the second dimension of the first exposed area of the battery cells on the first side of the core pack, respectively, and an area of the second section of the gap pad is defined by a first dimension and a second dimension and the second exposed area of the battery cells on the second side of the core pack is defined by a first dimension and a second dimension and wherein the first dimension and the second dimension of the area of the second section of the gap pad are approximately equal to the first dimension and the second dimension of the second exposed area of the battery cells on the second side of the core pack, respectively, and an area of the third section of the gap pad is defined by a first dimension and a second dimension and the third exposed area of the battery cells on the third side of the core pack is defined by a first dimension and a second dimension and wherein the first dimension and the second dimension of the area of the third section of the gap pad are approximately equal to the first dimension and the second dimension of the third exposed area of the battery cells on the third side of the core pack, respectively.

The aforementioned example embodiment may include a battery pack in which the first section of the gap pad has a first side, the second section of the gap pad has a first side and a second side opposed to the first side, and the third section of the gap pad has a first side, and the first side of the first section of the gap pad is coupled to the first side of the second section of the gap pad and the second side of the second section of the gap pad is coupled to the first side of the third section of the gap pad.

The aforementioned example embodiment may include a battery pack in which the first section of the gap pad and the second section of the gap pad meet at a first bend line in the gap pad, and the second section of the gap pad and the third section of the gap pad meet at a second bend line in the gap pad.

The aforementioned example embodiment may include a battery pack in which the first bend line and the second bend line are preformed impression in the gap pad designed to enable the gap pad to easily bend or partially fold along a predefined line.

Another aspect of the present disclosure includes a method of assembling a battery pack.

An example embodiment of the aforementioned method of assembling a battery pack may include a method including steps of providing a battery cell holder, positioning a plurality of battery cells in the battery cell holder to form a core pack, the core pack having a first side, a second side generally perpendicular to the first side and a third side generally perpendicular to the second side and generally opposed and parallel to the first side, providing a gap pad, the gap pad including (a) a first section, (b) a second section, and (c) a third section, aligning the first section of the gap pad with the first side of the core pack, affixing the first section of the gap pad to the first side of the core pack, bending the gap pad at a first bend line in the gap pad between the first section of the gap pad and the second section of the gap pad, affixing the second section of the gap pad to the second side of the core pack, bending the gap pad at a second bend line in the gap pad between the second section of the gap pad and the third section of the gap pad, and affixing the third section of the gap pad to the third side of the core pack.

The aforementioned example embodiment may further include a method of assembling a battery pack in which the gap pad is affixed to the plurality of battery cells.

The aforementioned example embodiment may further include a method of assembling a battery pack in which the gap pad is affixed to the plurality of battery cells by a glue or an adhesive.

The aforementioned example embodiment may further include a method of assembling a battery pack in which upon positioning the plurality of battery cells in the cell holder, a first area of the plurality of battery cells is exposed on the first side of the core pack and a second area of the plurality of battery cells is exposed on the second side of the core pack and a third area of the plurality of battery cells is exposed on the third side of the core pack.

The aforementioned example embodiment may further include a method of assembling a battery pack in which the aligning and affixing the first section of the gap pad with the first side of the core pack includes aligning and affixing an area of the first section of the gap pad with the first exposed area of the battery cells and the affixing the second section of the gap pad with the second side of the core pack includes affixing an area of the second section of the gap pad with the second exposed area of the battery cells and the affixing the third section of the gap pad with the third side of the core pack includes affixing an area of the third section of the gap pad with the third exposed area of the plurality of battery cells.

The aforementioned example embodiment may further include a method of assembling a battery pack in which the area of the first section of the gap pad is defined by a first dimension and a second dimension and the first exposed area of the plurality of battery cells is defined by a first dimension and a second dimension and upon affixing the gap pad to the core pack the first dimension and the second dimension of the area of the first section of the gap pad are aligned, respectively, with the first dimension and the second dimension of the first exposed area of the plurality of battery cells and the area of the second section of the gap pad is defined by a first dimension and a second dimension and the second exposed area of the plurality of battery cells is defined by a first dimension and a second dimension and upon affixing the gap pad to the core pack the first dimension and the second dimension of the area of the second section of the gap pad are aligned, respectively, with the first dimension and the second dimension of the second exposed area of the plurality of battery cells and the area of the third section of the gap pad is defined by a first dimension and a second dimension and the third exposed area of the plurality of battery cells is defined by a first dimension and a second dimension and upon affixing the gap pad to the core pack the first dimension and the second dimension of the area of the third section of the gap pad are aligned, respectively, with the first dimension and the second dimension of the third exposed area of the plurality of battery cells.

The aforementioned example embodiment may further include a method of assembling a battery pack including defining the first exposed area of the plurality of battery cells by a first dimension and a second dimension and the area of the first section of the gap pad by a first dimension and a second dimension wherein the first dimension of the first exposed area of the plurality of battery cells is approximately equal to the first dimension of the area of the first section of the gap pad and the second dimension of the first exposed area of the plurality of battery cells is approximately equal to the second dimension of the area of the first section of the gap pad, and including defining the second exposed area of the plurality of battery cells by a first dimension and a second dimension and the area of the second section of the gap pad by a first dimension and a second dimension wherein the first dimension of the second exposed area of the plurality of battery cells is approximately equal to the first dimension of the area of the second section of the gap pad and the second dimension of the second exposed area of the plurality of battery cells is approximately equal to the second dimension of the area of the second section of the gap pad, and including defining the third exposed area of the plurality of battery cells by a first dimension and a second dimension and the area of the third section of the gap pad by a first dimension and a second dimension wherein the first dimension of the third exposed area of the plurality of battery cells is approximately equal to the first dimension of the area of the third section of the gap pad and the second dimension of the third exposed area of the plurality of battery cells is approximately equal to the second dimension of the area of the third section of the gap pad.

The aforementioned example embodiment may further include a method of assembling a battery pack in which the first exposed area of the plurality of battery cells is approximately equal to the area of the first section of the gap pad and the second exposed area of the plurality of battery cells is approximately equal to the area of the second section of the gap pad and the third exposed area of the plurality of battery cells is approximately equal to the area of the third section of the gap pad.

The aforementioned example embodiment may further include a method of assembling a battery pack in which affixing the first section of the gap pad to the core pack fully covers a vast majority of the first exposed area of the plurality of battery cells on the first side of the core pack and affixing the second section of the gap pad to the core pack fully covers a vast majority of the second exposed area of the plurality of battery cells on the second side of the core pack and affixing the third section of the gap pad to the core pack fully covers a vast majority of the third exposed area of the plurality of battery cells on the third side of the core pack.

These and other advantages and features will be apparent from the description and the drawings.

### BRIEF DESCRIPTION OF THE DRAWINGS

FIGS. 1A and 1B illustrate isometric views of an example battery pack of the instant application.

FIGS. 2A and 2B illustrate isometric views of an example core pack of the battery pack of FIGS. 1A and 1B.

FIG. 3 illustrates an isometric view of an example gap pad in a first (pre-assembly) configuration.

FIG. 4 illustrates an isometric view of the example gap pad in a second (post-assembly) configuration.

FIGS. 5A-5F illustrate isometric views of an example assembly of the gap pad of FIGS. 3 and 4 onto the core pack of FIGS. 2A and 2B.

### DETAILED DESCRIPTION

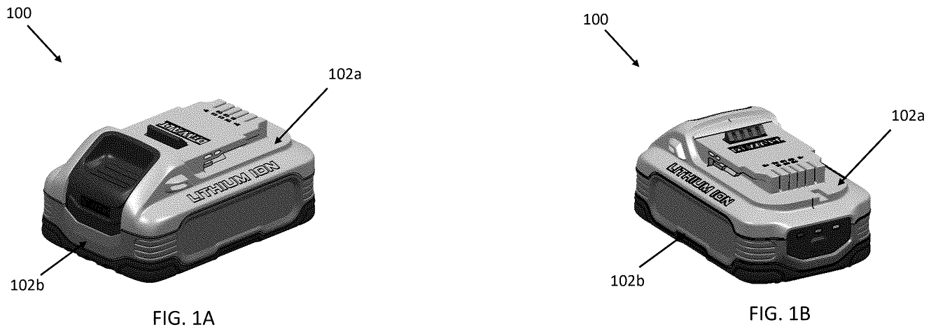

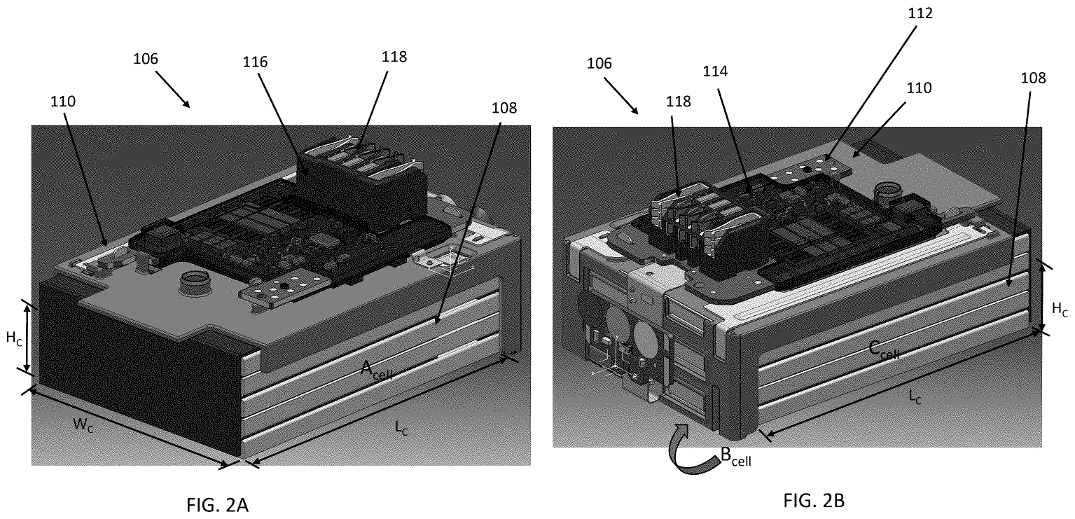

Referring to FIGS. 1 and 2, an example battery pack 100 includes a housing 102. The housing 102 may include an upper/top housing portion 102a and a lower/bottom housing portion 102b. The upper housing portion 102a and the lower housing portion 102b form an internal cavity. The internal cavity houses a core pack 106 (illustrated in FIGS. 2A and 2B).

Referring to FIGS. 2A and 2B, the core pack 106 may include a set (sometimes alternatively referred to as a plurality) of battery cells 108, a cell holder 110 for holding the plurality of battery cells 108 fixed relative to each other and providing a device for collecting and distributing voltage and current from and to the plurality of battery cells 108, a printed circuit board 112, a plurality of various electronic components 114 mounted on the printed circuit board 112, and a terminal block 116 including a plurality of battery pack terminals 118 configured to mate with a corresponding set of power tool terminals or set of charger terminals.

In the example core pack 106, the battery cells 108 may be pouch type battery cells. The pouch type battery cell 108 may include a pouch that holds internal components of the battery cell. The plurality of battery cells 108 may be in a stacked configuration. The plurality of stacked battery cells 108 may be received by the battery cell holder 110. As pouch type battery cells are charged and/or discharged, their temperature may rise and the pouch may expand.

In this example embodiment, the core pack 106 may have a first side A, a second side B (illustrated as a bottom side in the context of FIGS. 2A and 2B) generally perpendicular to the first side A and a third side C generally perpendicular to the second side B and generally parallel and opposed to the first side A.

The plurality of battery cells 108, when positioned in the cell holder 110, may present a first exposed area A_{cell} on the first side A of the core pack 106, a second exposed area B_{cell} on the second side B (a bottom side of the core pack in the context of FIGS. 2A and 2B) of the core pack 106, and a third exposed area C_{cell} on the third side C of the core pack 106. The first exposed area A_{cell} may be defined by a first dimension H_{C} and a second dimension L_{C}=>A_{cell}=H_{C}×L_{C}. The second exposed area B_{cell} may be defined by the first dimension L_{C} and a third dimension W_{C}=>B_{cell}=W_{C}×L_{C}. The third exposed area C_{cell} may also defined by the first dimension H_{C} and the second dimension L_{C}=>C_{cell}=H_{C}×L_{C}.

In general, gap pads are known. The gap pad 120, in general, serves to provide heat protection and expansion protection for the battery pack 100. The gap pad 120 may be comprised of material that operates as a thermal sink and may be pliable and compressive. As such, the gap pad 120 may absorb some of the heat generated by the battery cells 108 and allow the battery cells 108 to expand when their temperature rises and keep them stable within the housing when their temperature lowers and the battery cell 108 is not expanded. An example conventional gap pad is the BERGQUIST® GAP PAD TGP 10000ULM made by Henkel Corporation.

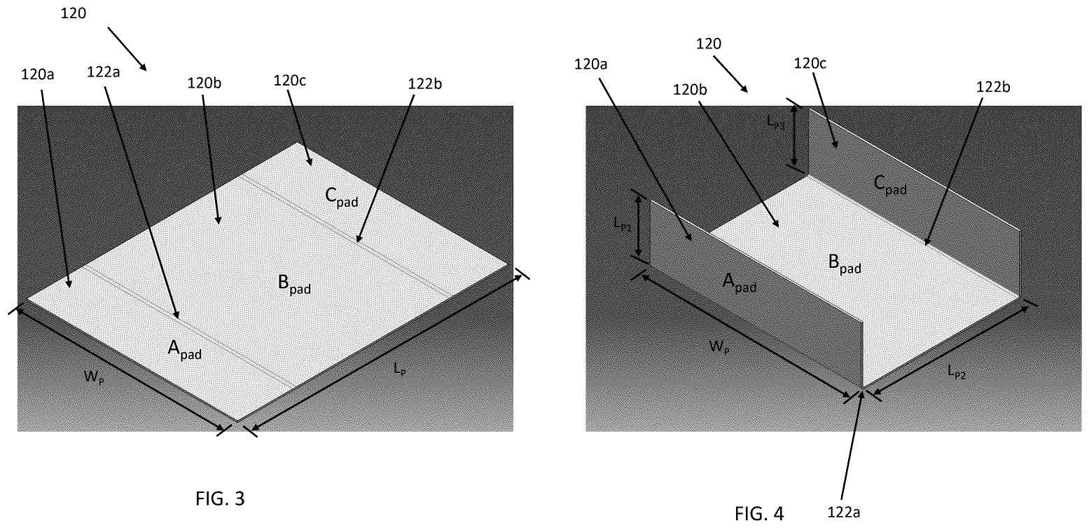

As illustrated in FIGS. 3 and 4, the example embodiment of the gap pad 120 of the instant application may include (a) a first (end) section or portion 120a, the first section 120a having a first side, (b) a second (central) section or portion 120b, the second section 120b having a first side and a second side opposed to the first side and (c) a third (end) section or portion 120c, the third section 120c having a first side. The first side of the first section 120a of the gap pad 120 may abut or be coupled to the first side of the second section 120b of the gap pad 120 and the second side of the second section 120b of the gap pad 120 may abut or be coupled to the first side of the third section 120c of the gap pad 120. The first section 120a of the gap pad 120 and the second section 120b of the gap pad 120 may meet or be separated by a first “bend line” 122a in the gap pad 120. A bend line may be a preformed or predefined impression/depression/indentation in the material of the gap pad 120. A bend line 122 is designed to enable the gap pad 120 to easily bend along a predefined line. The second section 120b of the gap pad 120 and the third section 120c of the gap pad 120 may meet or be separated by a second bend line 122b in the gap pad 120.

As illustrated in FIG. 4, the first bend line 122a and the second bend line 122b in the gap pad 120 enable the gap pad 120 to be partially folded or bent such that the first section 120a of the gap pad 120 and the third section 120c of the gap pad 120 are positioned or configured to be approximately perpendicular to the second section 120b of the gap pad 120 and be approximately parallel to each other.

The gap pad 120 may have a first dimension W_{P} and a second dimension L_{P} forming a generally rectangular gap pad 120 having a total area=W_{P}×L_{P}. The first section 120a of the gap pad 120 may have a first dimension W_{P} and a second dimension L_{P1} forming a generally rectangular first area A_{pad} of the gap pad 120=>A_{pad}=W_{P}×L_{P1}. The second section 120b of the gap pad 120 may have a first dimension W_{P} and a second dimension L_{P2} forming a generally rectangular second area B_{pad} of the gap pad 120=>B_{pad}=W_{P}×L_{P2}. The third section 120c of the gap pad 120 may have a first dimension W_{P} and a second dimension L_{P3} forming a generally rectangular third area C_{pad} of the gap pad 120=>C_{pad}=W_{P}×L_{P3}. The dimension L_{P1} may be equal to the dimension L_{P3}.

The dimension W_{P} of the gap pad 120 may be approximately equal to the dimension L_{C} of the battery cells 108/core pack 106. The dimensions L_{P1} and L_{P3} of the gap pad 120 may be approximately equal to the dimension H_{C} of the battery cells 108/core pack 106. The dimension L_{P2} of the gap pad 120 may be approximately equal to the dimension W_{C} of the battery cells 108/core pack 106.

The area A_{cell} may be approximately equal to the area A_{pad} (A_{cell}≈A_{pad}) and the area B_{cell} may be approximately equal to the area B_{pad} (B_{cell}≈B_{pad}) and the area C_{cell} may be approximately equal to the area C_{pad} (C_{cell}≈C_{pad}).

The first section 120a of the gap pad 120 may be coupled/affixed to the first side A of the core pack 106 and the second section 120b of the gap pad 120 may be coupled/affixed to the second side B of the core pack 106 and the third section 120c of the gap pad 120 may be coupled/affixed to the third side C of the core pack. More particularly, the first section 120a of the gap pad 120 may be coupled/affixed to the first exposed area A_{cell} on the first side A of the core pack 106, the second section 120b of the gap pad 120 may be coupled/affixed to the second exposed area B_{cell} on the second side B (the bottom side of the core pack in the context of FIGS. 2A and 2B) of the core pack 106, and the third section 120c of the gap pad 120 may be coupled/affixed to the third exposed area C_{cell} on the third side C of the core pack 106.

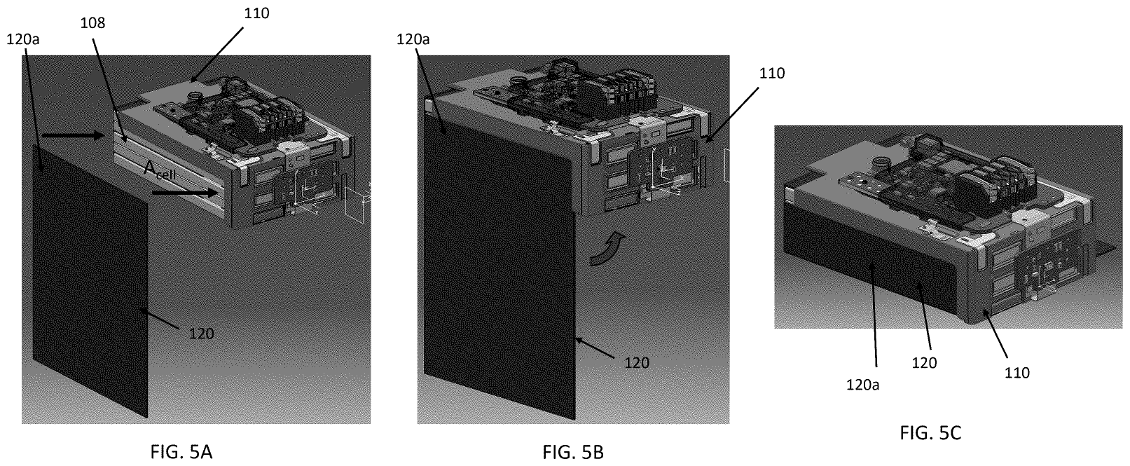

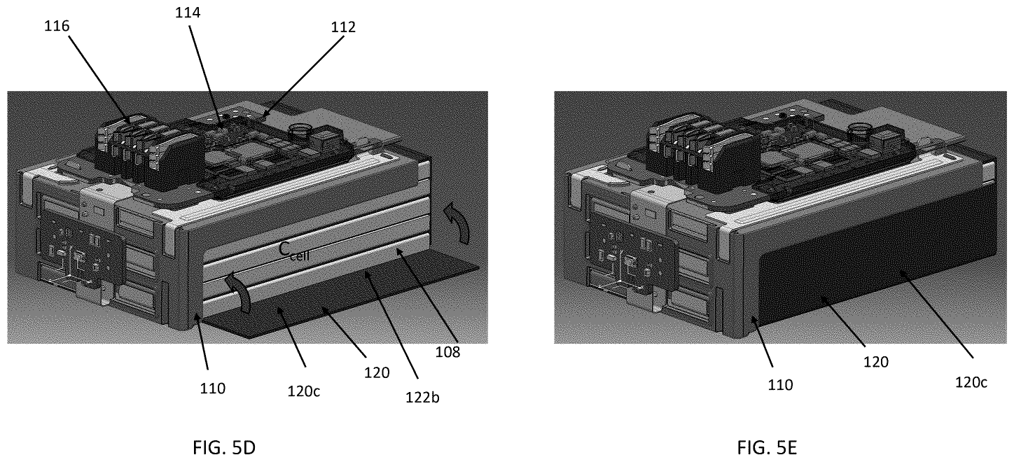

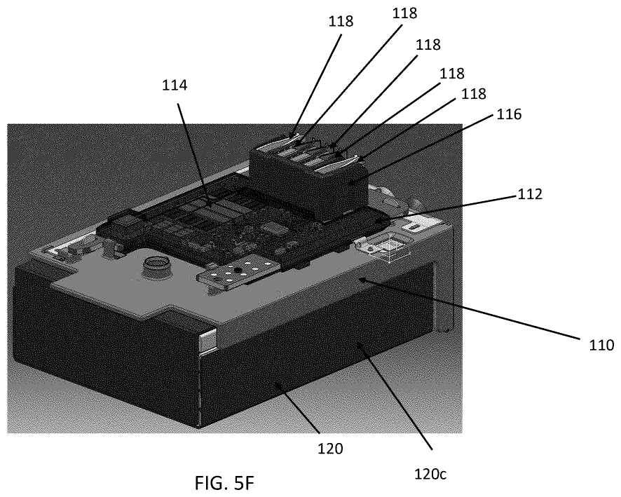

FIGS. 5A-5F illustrate an example method/process of assembling a battery pack 100. Specifically, the figures illustrate a method of assembling the example gap pad 120 to a core pack 106. As illustrated in FIG. 5A, the gap pad 120 is positioned such that the first section 120a of the gap pad 120 is aligned with a first side A of the core pack 106. More specifically, on the first side A of the core pack 106, the first area A_{pad} of the first section 120a of the gap pad 120, defined by the dimensions L_{P1}×W_{P}, is aligned with the first exposed area A_{cell} of the battery cells 108, defined by the dimensions H_{C}×L_{C}. As indicated in FIG. 5A, the gap pad 120 is applied to the core pack 106 in the direction of the arrows. The first section 120a of the gap pad 120 may be affixed to the first side A of the core pack 106 and more particularly, to sides of the battery cells 108. The gap pad 120 may be affixed to the battery cells 108 by an adhesive or a glue, that is well known in the art. As noted above, the first area A_{pad} of the first section 120a of the gap pad 120 is generally the same as the exposed area A_{cell} of the exposed sides of the battery cells 108 on the first side A of the core pack 106. In other words, L_{P1}×W_{P} is approximately equal to H_{C}×L_{C}. As such, the first section 120a of the gap pad 120 fully covers a vast majority of the exposed sides of the battery cells 108 on the first side A of the core pack 106.

As illustrated in FIG. 5B, once the first section 120a of the gap pad 120 is applied/affixed to the core pack 106, the gap pad 120 is bent or partially folded, in the direction of the arrow, at the first bend line 122a in the gap pad 120 between the first section 120a and the second section 120b.

As illustrated in FIG. 5C, the second section 120b of the gap pad 120 is applied/affixed to the bottom of the core pack 106. For example, the second section 120b may be affixed to the bottom side B of the core pack 106 and more particularly, to a side of a bottom battery cell 108 in the stack of battery cells 108. The gap pad 120 may be affixed to the battery cell 108 by an adhesive or a glue, that is well known in the art. As noted above, the second area B_{pad} of the second section 120b of the gap pad 120 is generally the same as the exposed area B_{cell} of the exposed side of the bottom most battery cell 108 on the bottom side B of the core pack 106. In other words, L_{P2}×W_{P} is approximately equal to W_{C}×L_{C}. As such, the second section 120b of the gap pad 120 fully covers a vast majority of the exposed side of the bottom battery cell 108 on the second side B of the core pack 106.

As indicated in FIG. 5D, the gap pad 120 is bent or partially folded, in the direction indicated by the arrows, at the second bend line 122b in the gap pad 120 between the second section 120b of the gap pad 120 and the third section 120c of the gap pad 120.

As illustrated in FIGS. 5E and 5F, the third section 120c of the gap pad 120 is applied/affixed to the core pack 120. For example, the third section 120c of the gap pad 120 may be affixed to the third side C of the core pack 106 and more particularly, to sides of the battery cells 108. The gap pad 120 may be affixed to the battery cells 108 by an adhesive or a glue, that is well known in the art. As noted above, the area C_{pad} of the third section 120c of the gap pad 120 is generally the same as the exposed area C_{cell} of the exposed sides of the battery cells 108 on the third side C of the core pack 106. In other words, L_{P3}×W_{P} is approximately equal to H_{C}×L_{C}. As such, the third section 120c of the gap pad 120 fully covers a vast majority of the exposed sides of the battery cells 108 on the third side C of the core pack 106.

Numerous modifications may be made to the exemplary implementations described above. These and other implementations are within the scope of this application.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A battery pack, comprising:
a core pack including a battery cell holder and a plurality of battery cells, the core pack having a first side, a second side generally perpendicular to the first side and a third side generally perpendicular to the second side and generally opposed and parallel to the first side; and
a gap pad, the gap pad including (a) a first section, (b) a second section, and (c) a third section,
the first section of the gap pad coupled to the first side of the core pack, the second section of the gap pad coupled to the second side of the core pack, and the third section of the gap pad coupled to the third side of the core pack.

2. The battery pack as recited in claim 1, wherein the plurality of battery cells has a first exposed area on the first side of the core pack, a second exposed area on the second side of the core pack, and a third exposed area on the third side of the core pack, and
wherein the first section of the gap pad is coupled to the first exposed area of the battery cells on the first side of the core pack, the second section of the gap pad is coupled to the second exposed area of the battery cells on the second side of the core pack, and the third section of the gap pad is coupled to the third exposed area of the battery cells on the third side of the core pack.

3. The battery pack as recited in claim 2, wherein an area of the first section of the gap pad is approximately equal to the first exposed area of the battery cells on the first side of the core pack and an area of the second section of the gap pad is approximately equal to the second exposed area of the battery cells on the second side of the core pack and an area of the third section of the gap pad is approximately equal to the third exposed area of the battery cells.

4. The battery pack as recited in claim 2, wherein an area of the first section of the gap pad is defined by a first dimension and a second dimension and the first exposed area of the battery cells on the first side of the core pack is defined by a first dimension and a second dimension and wherein the first dimension and the second dimension of the area of the first section of the gap pad are approximately equal to the first dimension and the second dimension of the first exposed area of the battery cells on the first side of the core pack, respectively, and
wherein an area of the second section of the gap pad is defined by a first dimension and a second dimension and the second exposed area of the battery cells on the second side of the core pack is defined by a first dimension and a second dimension and wherein the first dimension and the second dimension of the area of the second section of the gap pad are approximately equal to the first dimension and the second dimension of the second exposed area of the battery cells on the second side of the core pack, respectively, and
wherein an area of the third section of the gap pad is defined by a first dimension and a second dimension and the third exposed area of the battery cells on the third side of the core pack is defined by a first dimension and a second dimension and wherein the first dimension and the second dimension of the area of the third section of the gap pad are approximately equal to the first dimension and the second dimension of the third exposed area of the battery cells on the third side of the core pack, respectively.

5. The battery pack as recited in claim 1, wherein the first section of the gap pad has a first side, the second section of the gap pad has a first side and a second side opposed to the first side, and the third section of the gap pad has a first side, and
wherein the first side of the first section of the gap pad is coupled to the first side of the second section of the gap pad and the second side of the second section of the gap pad is coupled to the first side of the third section of the gap pad.

6. The battery pack as recited in claim 5, wherein the first section of the gap pad and the second section of the gap pad meet at a first bend line in the gap pad, and
wherein the second section of the gap pad and the third section of the gap pad meet at a second bend line in the gap pad.

7. The battery pack as recited in claim 6, wherein the first bend line and the second bend line are preformed impression in the gap pad designed to enable the gap pad to easily bend along a predefined line.

8. A method of assembling a battery pack, the method comprising steps of:
providing a battery cell holder,
positioning a plurality of battery cells in the battery cell holder to form a core pack, the core pack having a first side, a second side generally perpendicular to the first side and a third side generally perpendicular to the second side and generally opposed and parallel to the first side,
providing a gap pad, the gap pad including (a) a first section, (b) a second section, and (c) a third section,
aligning the first section of the gap pad with the first side of the core pack,
affixing the first section of the gap pad to the first side of the core pack,
bending the gap pad at a first bend line in the gap pad between the first section of the gap pad and the second section of the gap pad,
affixing the second section of the gap pad to the second side of the core pack,
bending the gap pad at a second bend line in the gap pad between the second section of the gap pad and the third section of the gap pad, and
affixing the third section of the gap pad to the third side of the core pack.

9. The method of claim 8, wherein the gap pad is affixed to the plurality of battery cells.

10. The method as recited in claim 8, wherein the gap pad is affixed to the plurality of battery cells by a glue or an adhesive.

11. The method as recited in claim 8, wherein upon positioning the plurality of battery cells in the cell holder, a first area of the plurality of battery cells is exposed on the first side of the core pack and a second area of the plurality of battery cells is exposed on the second side of the core pack and a third area of the plurality of battery cells is exposed on the third side of the core pack.

12. The method as recited in claim 11, wherein the aligning and affixing the first section of the gap pad with the first side of the core pack includes aligning and affixing an area of the first section of the gap pad with the first exposed area of the battery cells and the affixing the second section of the gap pad with the second side of the core pack includes affixing an area of the second section of the gap pad with the second exposed area of the battery cells and the affixing the third section of the gap pad with the third side of the core pack includes affixing an area of the third section of the gap pad with the third exposed area of the plurality of battery cells.

13. The method as recited in claim 12, wherein the area of the first section of the gap pad is defined by a first dimension and a second dimension and the first exposed area of the plurality of battery cells is defined by a first dimension and a second dimension and upon affixing the gap pad to the core pack the first dimension and the second dimension of the area of the first section of the gap pad are aligned, respectively, with the first dimension and the second dimension of the first exposed area of the plurality of battery cells and the area of the second section of the gap pad is defined by a first dimension and a second dimension and the second exposed area of the plurality of battery cells is defined by a first dimension and a second dimension and upon affixing the gap pad to the core pack the first dimension and the second dimension of the area of the second section of the gap pad are aligned, respectively, with the first dimension and the second dimension of the second exposed area of the plurality of battery cells and the area of the third section of the gap pad is defined by a first dimension and a second dimension and the third exposed area of the plurality of battery cells is defined by a first dimension and a second dimension and upon affixing the gap pad to the core pack the first dimension and the second dimension of the area of the third section of the gap pad are aligned, respectively, with the first dimension and the second dimension of the third exposed area of the plurality of battery cells.

14. The method as recited in claim 12,
further comprising defining the first exposed area of the plurality of battery cells by a first dimension and a second dimension and the area of the first section of the gap pad by a first dimension and a second dimension wherein the first dimension of the first exposed area of the plurality of battery cells is approximately equal to the first dimension of the area of the first section of the gap pad and the second dimension of the first exposed area of the plurality of battery cells is approximately equal to the second dimension of the area of the first section of the gap pad, and
further comprising defining the second exposed area of the plurality of battery cells by a first dimension and a second dimension and the area of the second section of the gap pad by a first dimension and a second dimension wherein the first dimension of the second exposed area of the plurality of battery cells is approximately equal to the first dimension of the area of the second section of the gap pad and the second dimension of the second exposed area of the plurality of battery cells is approximately equal to the second dimension of the area of the second section of the gap pad, and
further comprising defining the third exposed area of the plurality of battery cells by a first dimension and a second dimension and the area of the third section of the gap pad by a first dimension and a second dimension wherein the first dimension of the third exposed area of the plurality of battery cells is approximately equal to the first dimension of the area of the third section of the gap pad and the second dimension of the third exposed area of the plurality of battery cells is approximately equal to the second dimension of the area of the third section of the gap pad.

15. The method as recited in claim 12, wherein the first exposed area of the plurality of battery cells is approximately equal to the area of the first section of the gap pad and the second exposed area of the plurality of battery cells is approximately equal to the area of the second section of the gap pad and the third exposed area of the plurality of battery cells is approximately equal to the area of the third section of the gap pad.

16. The method of claim 11, wherein affixing the first section of the gap pad to the core pack fully covers a vast majority of the first exposed area of the plurality of battery cells on the first side of the core pack and affixing the second section of the gap pad to the core pack fully covers a vast majority of the second exposed area of the plurality of battery cells on the second side of the core pack and affixing the third section of the gap pad to the core pack fully covers a vast majority of the third exposed area of the plurality of battery cells on the third side of the core pack.
